(19) United States
(12) Patent Application Publication
(10) Pub. No.: US 2014/0298256 A1
(43) Pub. Date: Oct. 2, 2014

(54) EXPANDING BUTTON

(71) Applicants: Egan Schulz, San Jose, CA (US); Michelle Serrano, San Jose, CA (US)

(72) Inventors: Egan Schulz, San Jose, CA (US); Michelle Serrano, San Jose, CA (US)

(21) Appl. No.: 13/854,878

(22) Filed: Apr. 1, 2013

(51) Int. Cl. G06F 3/0484

(52) U.S. Cl. CPC G06F 3/04842
USPC 715/808

(57) ABSTRACT

Systems and methods for facilitating user action on a user device are described. The methods include presenting an expanding button or link on a display of the user device, receiving an input from a user on the expanding button or link, and expanding the expanding button or link to present a screen associated with the user input and positioned at a location of the expanding button or link.

### BACKGROUND

1. Field of the Invention

The invention is directed towards facilitating user action on a user device.

2. Related Art

Users have long been able to view information displayed on a screen and to use input devices such as mice, keyboards, and track pads to move forward to a next action. Typically, when a user clicks or otherwise selects a link, he or she is taken to a brand new screen and the next action that must be taken is located at a different position than the link. The user must spend time locating the link and repositioning his or her finger and/or mouse over the link. Thus, a need exists for systems and methods that are more efficient and decrease the burden of progressing to the next step.

### BRIEF DESCRIPTION OF THE FIGURES

FIG. 1 is a block diagram of a networked system suitable for implementing the methods described herein according to an embodiment;

FIG. 2 is a flowchart showing a method of facilitating user action on a user device according to one embodiment;

FIGS. 3A-3B are screen shots showing a method of facilitating user action on a user device according to another embodiment; and

FIG. 4 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for facilitating ease of a user's actions on a user device. When a user encounters a button or link on a webpage, the user taps, clicks, or otherwise selects the button or link to initiate presentation of a new screen. The screen is presented to the user at or near the same location as the button or link. The user's gaze does not have to move from the location of the button or link. The button or link can expand or slide out to present a screen when the button or link is selected. The user can then perform the next action on the screen without having to move his or her fingers from the location of the button or link.

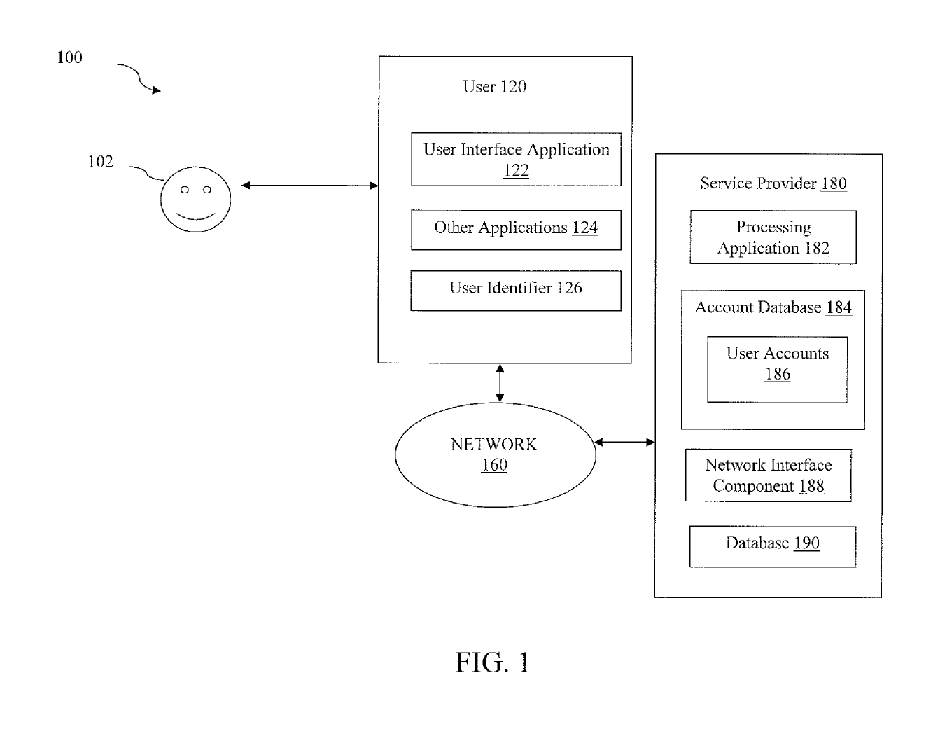

FIG. 1 illustrates an exemplary embodiment of a network-based system 100 for implementing one or more processes described herein over a network 160. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 and a service provider server 180 in communication over the network 160. Service provider server 180 may be maintained by a payment provider, such as PayPal®, Inc. of San Jose, Calif. Although a service provider device is shown, the server may be managed or controlled by any suitable service provider. A user 102 utilizes user device 120 to view account information and perform transactions using service provider server 180. Note that transaction, as used herein, refers to any suitable action performed using the user device 120, including payments, transfer of information, display of information, etc. Although only one server is shown, a plurality of servers may be utilized.

User device 120 and service provider server 180 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 120 may be implemented using any appropriate hardware and software configured for wired and/or wireless communication over network 160. For example, in one embodiment, the user device 120 may be implemented as a personal computer (PC), a smart phone, personal digital assistant (PDA), laptop computer, and/or other types of computing devices capable of transmitting and/or receiving data, such as an iPad from Apple®. In some embodiments, the user device 120 is a touchscreen device. User 102 can navigate websites in some such embodiments by using finger sweep gestures to the right and left to move items, and then tapping or double-tapping a selection window to select an item. Other embodiments may recognize different multi-touch gestures for navigating websites and selecting items.

User device 120, in one embodiment, includes a user interface application 122, which may be utilized by the user 102 to conduct transactions (e.g., shopping, purchasing, bidding, etc.) with the service provider server 180 over the network 160. In one aspect, purchase expenses may be directly and/or automatically debited from an account related to the user 102 via the user interface application 124.

In one implementation, the user interface application 124 comprises a software program, such as a graphical user interface (GUI), executable by a processor that is configured to interface and communicate with the service provider server 180 via the network 160. In another implementation, the user interface application 124 comprises a browser module that provides a network interface to browse information available over the network 160. For example, the user interface application 124 may be implemented, in part, as a web browser to view information available over the network 160. The web browser includes a feature that allows user 102 to select an expanding button or link to initiate presentation of a new screen that is located at or near the same location as the button or link. Expanding button software can be added to existing software suites with relative ease. The web browser may be any application that is used to search for and display content on a distributed data processing system. Suitable browsers include Netscape Navigator, Microsoft Internet Explorer, Mozilla Firefox, and Google Chrome.

User device 120 may also include one or more toolbar applications that may be used, for example, to provide client-side processing for performing desired tasks in response to operations selected by user 102. In one embodiment, the toolbar application may display a user interface in connection with a browser application.

User device 102 may further include other applications 124 as may be desired in particular embodiments to provide desired features to user device 120. For example, other applications 124 may include security applications for implementing client-side security features, programmatic client applications for interfacing with appropriate application programming interfaces (APIs) over network 160, or other types of applications. Other applications 124 may also include email, texting, voice and IM applications that allow user 102 to send and receive emails, calls, and texts through network 160, as well as applications that enable the user to communicate and transfer information through the service provider. User device 120 includes one or more user identifiers 126 which may be implemented, for example, as operating system registry entries, cookies associated with the browser, identifiers associated with hardware of user device 120, or other appropriate identifiers, such as used for payment/user/device authentication. In one embodiment, user identifier 126 may be used by a service provider to associate user 102 with a particular account maintained by the service provider. Other applications 126 may include a communications application, with associated interfaces, that enables user device 120 to communicate within system 100.

Service provider server 180 may be maintained, for example, by an online payment service provider which may provide information to and receive information from user 102, such as for making payments. In this regard, service provider server 180 includes one or more processing applications 182 which may be configured to interact with user device 120 over network 160 to facilitate sending payments from user 102 of user device 120. In one example, the service provider server 180 may be provided by PayPal®, Inc. of San Jose, Calif., USA.

Service provider server 180 also maintains an account database 184 for storing a plurality of user accounts 186, including user 102, each of which may include account information associated with consumers, merchants, and funding sources, such as credit card companies. For example, account information may include private financial information of users of devices such as account numbers, passwords, device identifiers, user names, phone numbers, credit card information, bank information, identification cards, photos, or other information which may be used to facilitate transactions by user 102.

The service provider server 180, in various embodiments, may include at least one network interface component (NIC) 188 adapted to communicate with the network 160 including the user interface application 122 of the user devices 120. In various implementations, the network interface component 188 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The service provider server 180, in various embodiments, may include one or more databases 190 (e.g., internal or external) for storing and tracking information related to users. The database 190 may store, for example, address data for communicating with the user device 120. The address data may include data for communicating a text message to user device 120, an e-mail address at which messages are receivable by user device 120, or any other manner for communicating with user device 120. Moreover, service provider server 180 may include computer executable instructions that are operative to cause the server 180 to generate message content appropriate for messages to be communicated to user device 120.

The system described above with respect to the embodiment of FIG. 1 may be used to facilitate ease of user action on a device. The user selects a button or link by clicking or tapping a button or link on a display of a user device. The button or link expands or slides out to present a new screen. The screen is at or near the same location as the button or link. The user can then perform the next action on the screen. The expanding button or link goes from rolled up to pulled out with a tap or click from the user.

For example, assume user 102 is browsing a merchant website, decides on an item to purchase, and selects the item. User 102 taps on the button/link associated with the item to add the item to the cart, and the new screen brings the user 102 to checkout, where a service provider can receive and process the payment.

In another example, user 102 is presented with buttons/links associated with certain people in his or her network. For instance, user 102 may be presented with various pictures of friends with a button/link within each picture. After selecting a picture, user 102 is presented with a next screen that includes text asking him or her to confirm that he or she wants to send money to the person selected.

Many other examples are encompassed by the present disclosure. User 102 is presented with a button/link associated with a search box. Upon clicking the button/link, the button/link expands or slides out, a search box is displayed to the user 102 at or near the location of the button/link, and user 102 performs a search by typing in search terms. User 102 is presented with a button/link associated with a request for location verification. User 102 selects the button/link, and the next screen requests the user 102 to confirm his or her location.

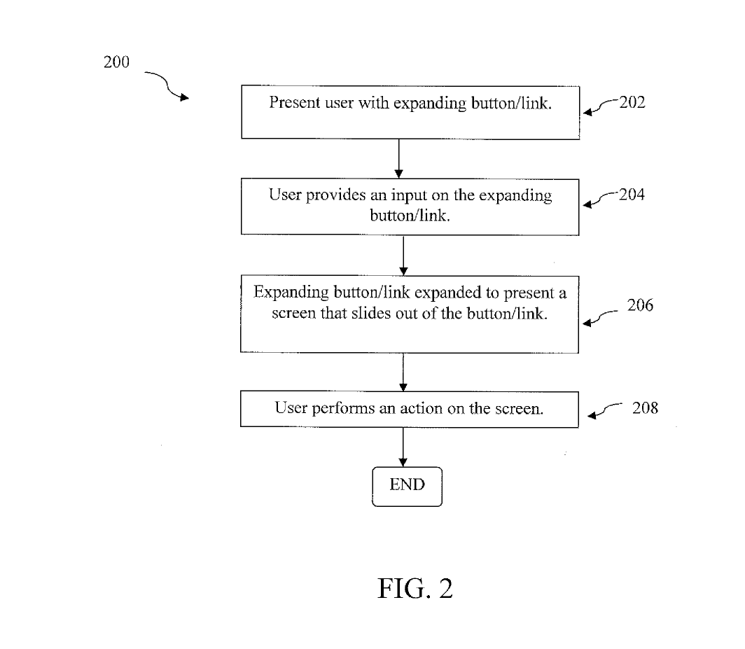

Referring now to FIG. 2, a flowchart of a method 200 for facilitating user action on a device is illustrated according to an embodiment of the present disclosure. It should be appreciated that the method illustrated in the embodiment of FIG. 2 may be implemented by the system illustrated in FIG. 1 according to one or more embodiments.

In an embodiment, at step 202, user 102 initiates a browser session, browses a website, and is presented with an expanding button or link. For example, user 102 may perform a search using his or her personal computer, tablet, mobile device or any other user device having a web browser with the expanding button feature. The expanding button or link defines an association between a starting resource, i.e., the source from which link traversal is begun, and an ending resource. The expanding button/link directs users to another screen, and allows users to click their way from screen to screen. The expanding button/link moves the user 102 onward to the next part of the process and closer to user 102's goal. In some embodiments, the expanding button/link is presented at a decision point for user 102.

The user 102 may encounter an expanding button/link at any time while surfing or exploring the Internet. For example, while shopping online, the user 102 can be presented with several buttons/links that direct the user to different categories of items, size charts, terms and conditions of use, store locations, a shopping bag, checkout application, etc. In another example, the user 102 may be on a website that allows him or her to download games, and various buttons/links to games, game reviews, terms of use, privacy policies, etc. may be displayed. As yet another example, user 102 may be on the PayPal® website and asked to select a funding source from several buttons/links.

In step 204, the user 102 provides an input on the expanding button/link. The user 102 selects any button/link on a main display screen with a user input device. Input can be received through a cursor controller such as a mouse, trackpad, touchpad, etc. (e.g., dragging, scrubbing, clicking, etc.) or through a keyboard (e.g., pressing arrow keys, the <Enter> key, etc.). Examples of such inputs include mouse inputs (e.g., double-clicks, clicks combined with keyboard inputs, etc.), keyboard inputs (e.g., the left and right arrow keys for scrolling and the <Enter> key for selection), touchscreen or touchpad inputs, etc. In some embodiments, the touchscreens do not actually use a cursor. Instead, to advance a screen by one item to the right, a user can tap on the left side of the screen, and to advance the screen by one item to the left, the user could tap on the right side of the screen. Selection could then be performed by a tap or double-tap on the selection window.

In one embodiment, the user 102 uses his or her finger to touch or tap the button/link. In another embodiment, user 102 can use a mouse or trackpad to move a pointer or cursor on the main display screen onto the button/link that the user 102 wishes to select. The user 102's selection is then communicated to and received by the service provider server 180.

In step 206, the expanding button/link is expanded to present a screen that slides out of the button/link. The button/link that was previously displayed is now replaced with the new content associated with the user input in step 204. The screen may any suitable shape, such as a circle, rectangle, semi-circle, etc., and generally has a larger area than the button/link.

In some embodiments, the screen gives the user 102 various options and additional buttons/links, such as a menu. Such menus often include lists of commands, for example, opening a file, printing a document, saving a document, sending a document, etc. The user 102 can provide an input on the screen.

Selecting a desired button/link directs the user 102 to an appropriate display to continue or advance in the process. In other embodiments, the screen provides the user 102 with text or instructions to read before allowing the user 102 to proceed. In various embodiments, when an action is performed on the screen, a second screen that slides out of the first screen is presented. The user 102 can then provide an input on the second screen.

The screen is advantageously positioned at the location of the expanding button/link that was selected so that the user 102's gaze and fingers do not have to move, and interaction with the web page is easier for the user 102. The user 102's attention is kept in one spot because the next action takes place where the user 102 has already touched or clicked. The next screen is presented at a set location, i.e., the same location as the button/link, so that the user 102 does not waste time searching for it. The user's gaze and finger are already in the correct location so he or she does not need to look toward the center of the display where the next screen or dialogue is usually located.

In step 208, the user 102 performs a next action on the screen. The next action can be a swipe, selecting a choice, reading further text or instructions, etc.

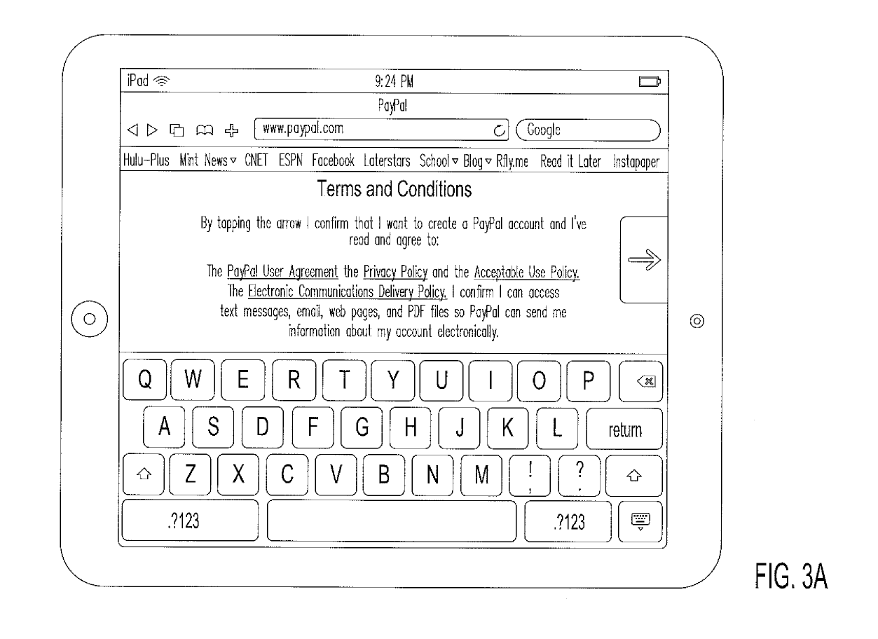

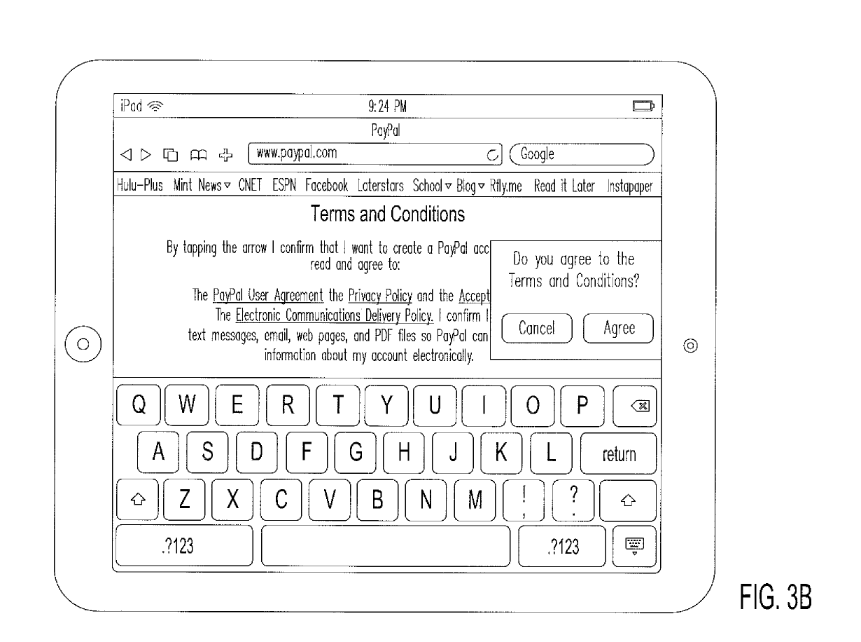

FIGS. 3A and 3B are sample screenshots showing a method of facilitating user actions on a device, according to one embodiment. The following description focuses on a touch screen display, such as on an iPad tablet from Apple®. It should be understood, however, that other displays and devices are also suitable. For example, instead of touching or tapping the expanding button/link, a user may move a pointer or cursor, such as with a mouse or trackball, to the button/link and click to select.

In FIG. 3A, the user has accessed the website of the service provider PayPal®, Inc. The user is presented with Terms and Conditions that he or she must accept before proceeding to create a PayPal® account. As shown, the user sees a right pointing arrow button on the right hand side of the main screen. In some embodiments, such a symbol (e.g., arrows, letter, etc.) is used to graphically indicate that the selection of the button will cause another screen or window to open up. In other embodiments, graphical indicators are not used, instead assuming that the user will know which buttons cause another window or screen to open.

The display indicates that by tapping the arrow, the user confirms that he or she wants to create a PayPal® account and has read and agreed to certain agreements and policies. Tapping on any other link (e.g., not the arrow) opens the link in a new browser window.

Upon tapping the arrow, the user is presented with the display in FIG. 3B. Tapping the arrow causes the arrow button to expand to show further dialogue in a new screen and present a choice for the user to make. The screen slides out of the button so it is in the same location as the button. In the illustrated case, the user must choose whether or not to agree to the Terms and Conditions. The user then selects whether to agree to the Terms and Conditions or whether to cancel the transaction. As such, the user is able to quickly and easily tap the “Agree” button to accept the Terms and Conditions without the user having to locate the button on a different part of the screen because the user's thumb or other finger may already be at or around a desired location (based on the user tap from the previous action).

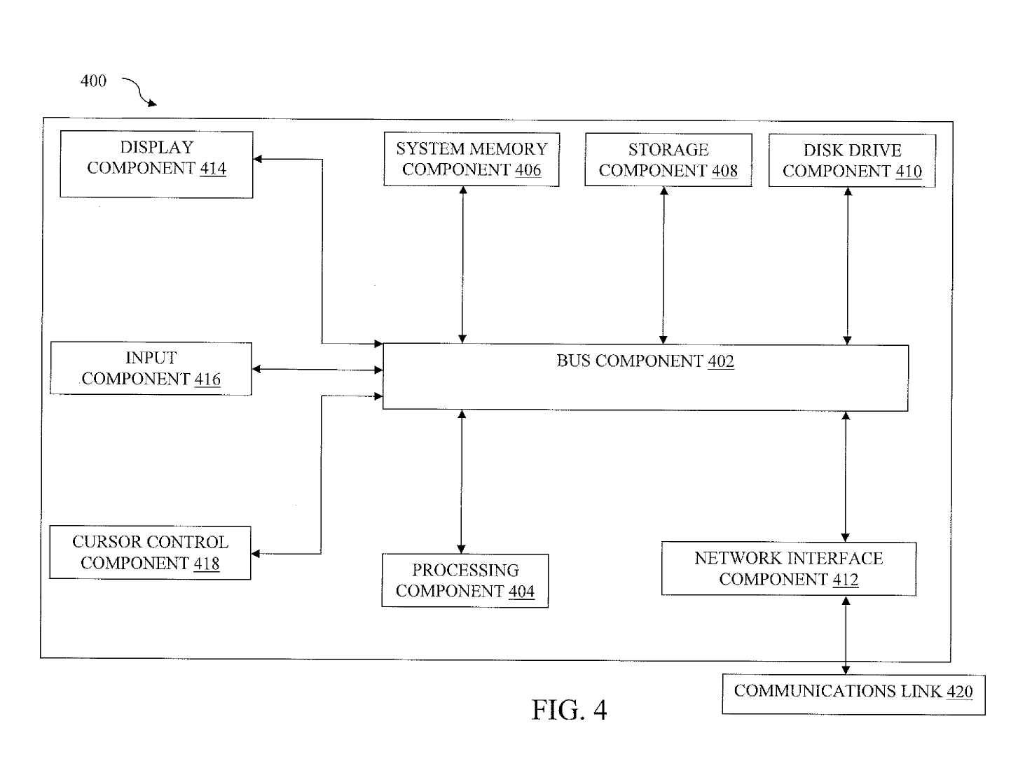

Referring now to FIG. 4, a block diagram of a system 400 is illustrated suitable for implementing embodiments of the present disclosure, including user device 120 and service provider server 180. System 400, such as part of a cell phone, a tablet, a personal computer and/or a network server, includes a bus 402 or other communication mechanism for communicating information, which interconnects subsystems and components, including one or more of a processing component 404 (e.g., processor, micro-controller, digital signal processor (DSP), etc.), a system memory component 406 (e.g., RAM), a static storage component 408 (e.g., ROM), a network interface component 412, a display component 414 (or alternatively, an interface to an external display), an input component 416 (e.g., keypad or keyboard), and a cursor control component 418 (e.g., a mouse pad).

In accordance with embodiments of the present disclosure, system 400 performs specific operations by processor 404 executing one or more sequences of one or more instructions contained in system memory component 406. Such instructions may be read into system memory component 406 from another computer readable medium, such as static storage component 408. These may include instructions to present an expanding button/link, expand the expanding button/link, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, volatile media includes dynamic memory, such as system memory component 406, and transmission media includes coaxial cables, copper wire, and fiber optics, including wires that comprise bus 402. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 400. In various other embodiments, a plurality of systems 400 coupled by communication link 420 (e.g., network 160 of FIG. 1, LAN, WLAN, PTSN, or various other wired or wireless networks) may perform instruction sequences to practice the disclosure in coordination with one another. Computer system 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

In view of the present disclosure, it will be appreciated that various methods and systems have been described according to one or more embodiments for facilitating user actions on a device.

Although various components and steps have been described herein as being associated with user device 120 and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise, Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A system, comprising:
a memory device storing user account information, wherein the user account information comprises financial information for a user account; and
one or more processors in communication with the memory device and operable to:
present an expanding button or link on a display of a user device;
receive an input from a user on the expanding button or link; and
expand the expanding button or link to present a screen associated with the user input and positioned at a location of the expanding button or link.

2. The system of claim 1, wherein the expanding button or link comprises a graphic indicator, text, or a combination thereof.

3. The system of claim 1, wherein the display comprises a touch-screen display.

4. The system of claim 1, wherein the one or more processors is further operable to receive an input on the screen.

5. The system of claim 4, wherein the input comprises a mouse input, keyboard input, touchscreen input, or a combination thereof.

6. The system of claim 1, wherein the screen presents a choice that the user must make to proceed.

7. The system of claim 1, wherein the one or more processors are further operable to present a second screen that slides out of the screen,

8. The system of claim 7, wherein the one or more processors is further operable to receive an input on the second screen.

9. A method of facilitating user action on a user device, comprising:
presenting, by one or more hardware processors of a service provider, an expanding button or link on a display of the user device;
receiving an input from a user on the expanding button or link; and
expanding the expanding button or link to present a screen associated with the user input and positioned at a location of the expanding button or link.

10. The method of claim 9, wherein the expanding button or link comprises a graphic indicator, text, or a combination thereof

11. The method of claim 9, wherein the display comprises a touch-screen display.

12. The method of claim 9, further comprising receiving an input on the screen.

13. The method of claim 9, wherein the screen presents a choice that the user must make to proceed.

14. The method of claim 9, further comprising presenting a second screen that slides out of the screen.

15. A non-transitory machine-readable medium comprising a plurality of machine-readable instructions which, when executed by one or more processors, are adapted to cause the one or more processors to perform a method comprising:
presenting an expanding button or link on a display of the user device;
receiving an input from a user on the expanding button or link; and
expanding the expanding button or link to present a screen associated with the user input and positioned at a location of the expanding button or link.

16. The non-transitory machine-readable medium of claim 15, wherein the expanding button or link comprises a graphic indicator, text, or a combination thereof.

17. The non-transitory machine-readable medium of claim 15, wherein the display comprises a touch-screen display.

18. The non-transitory machine-readable medium of claim 15, wherein the method further comprises receiving an input on the screen.

19. The non-transitory machine-readable medium of claim 15, wherein the screen presents a choice that the user must make to proceed.

20. The non-transitory machine-readable medium of claim 15, wherein the method further comprises presenting a second screen that slides out of the screen.
